(19) United States
(12) Patent Application Publication
(10) Pub. No.: US 2017/0272466 A1
(43) Pub. Date: Sep. 21, 2017

(54) SECURITY SYSTEM, SECURITY METHOD, AND COMPUTER-READABLE MEDIUM

(71) Applicant: NEC Corporation, Tokyo (JP)

(72) Inventor: Takahiro KAKUMARU, Tokyo (JP)

(73) Assignee: NEC Corporation, Tokyo (JP)

(21) Appl. No.: 15/505,381

(22) PCT Filed: May 15, 2015
(86) PCT No.: PCT/JP2015/002458

§ 371 Date: Feb. 21, 2017

(30) Foreign Application Priority Data
Aug. 25, 2014 (JP) 2014-170368

(51) Int. Cl. H04L 29/06

(52) U.S. Cl. CPC H04L 63/1491; H04L 63/1425; H04L 63/168

(57) ABSTRACT

To provide a high-secured security system, security method, and program. The security system that defends against unauthorized invasion to a network system. The security system according to the example embodiments of the present invention includes: a packet reception unit that receives a packet from an invasion device (300) that attempts unauthorized invasion; a characteristic-information accumulation unit (17) that stores characteristic information of a plurality of virtual simulated hosts; a simulated host startup management unit (18) that manages whether or not to activate the simulated hosts (111-114) based on the characteristic information; a simulated host management unit (16) that determines whether or not the plurality of simulated hosts (111-114) activated by the simulated host startup management unit (18) respond based on a request included in the packet; a simulated-response generation unit (19) that generates a simulated response according to the request to the simulated hosts, for each of the simulated hosts that is determined to respond by the simulated host management unit (16); and a simulated-response transmission unit (23) that transmits the simulated response to the invasion device (300).

### TECHNICAL FIELD

The present invention relates to a security system of a network, a security method, and a computer-readable medium.

### BACKGROUND ART

PTL 1 discloses a communication monitoring system which generates a simulated host device when it is possible to estimate that there is a malice. The communication monitoring system in PTL 1 generates a simulated response as if an attack from a malicious attacker is successful.

Further, PTL 2 discloses an unauthorized invasion detection device which generates a decoy in a device accessible via a network. The unauthorized invasion detection device in PTL 2 detects invasion of an attacker on the basis of a degree of coincidence between an event pattern of access control to the decoy, and a behavior pattern stored in a behavior pattern database. Specifically, occurrence of a targeted attack is detected by detecting a behavior of an attacker searching inside an intra-organization network.

### CITATION LIST

### Patent Literature

PTL 1: Japanese Laid-open Patent Publication No. 2013-9185

PTL 2: International Publication No. WO2014/103115

### SUMMARY OF INVENTION

### Technical Problem

In PTL 1, it is necessary to estimate in advance that there is a malice. Therefore, regarding a newly developed attack, it may not be possible to estimate that there is a malice. Further, in PTL 2, when an event pattern does not coincide with a behavior pattern stored in the behavior pattern database, it is not possible to detect invasion of an attacker. Therefore, it may not be possible to detect invasion of an attacker regarding a behavior pattern of a newly developed attack.

It is difficult to prevent unauthorized invasion through a network. The security cost may be raised in order to prevent a system from being infected with a malware. For instance, when deletion or defense is repeated each time unauthorized invasion (an attack) from the outside is detected, the defense cost may be raised.

In particular, regarding defense and attack in a cyberspace, an attacker can attack from everywhere, on the other hand, a defender is required to defend against an attack from everywhere. Further, an attacker is allowed to fail, but a defender is not allowed to fail. A defender is required to securely defend against all the attacks. An attacker can gain an insight into a defensive network with a slight amount of money, but a defender is required to spend a large amount of money for configuring and maintaining a network security. Further, an attacker may receive benefits of technical and systematic innovations of a cyberspace, but a defender is likely to be threatened by innovations.

As described above, an attacker has superiority over a defender due to the nature of cybersecurity. Therefore, it is important to set the cost advantage of a defender-side high by increasing the attack cost in order to enhance the network security. Specifically, it is possible to enhance the security firstly by imposing on an attacker a larger amount of money as an attack cost, and then by implementing a defense in depth for minimizing the damage.

For instance, it is important to minimize an influence by an attack based on the premise that a system is infected with a malware. The damage is serious when important data such as intellectual properties on a network leaks. In view of the above, it is important to prevent leakage of important data due to unauthorized invasion.

An object of the present invention is to provide a high-secured security system, security method, and program.

### Solution to Problem

An aspect of the present invention is:

a security system that defends against unauthorized invasion to a network system. The system includes:

a packet reception means that receives a packet from an invasion device that attempts unauthorized invasion;

a characteristic-information accumulation means that stores characteristic information of a plurality of virtual simulated devices;

a startup management means that manages whether or not to activate the simulated devices based on the characteristic information;

a simulated device management means that determines whether or not the plurality of simulated devices activated by the startup management means respond based on a request included in the packet;

a simulated-response generation means that generates a simulated response according to the request to the simulated devices, for each of the simulated devices that is determined to respond by the simulated device management means; and

a simulated-response transmission means that transmits the simulated response to the invasion device.

Other aspect of the present invention is:

a security method for defending against unauthorized invasion to a network system. The method includes:

a step of receiving a packet from an invasion device that attempts unauthorized invasion;

a step of managing whether or not to activate a plurality of virtual simulated devices by referring to characteristic information of the plurality of virtual simulated devices stored in advance;

a step of determining whether or not the plurality of activated simulated devices respond based on a request included in the packet;

a step of generating a simulated response according to the request, for each of the simulated devices that is determined to respond; and

a step of transmitting the simulated response to the invasion device.

Other aspect of the present invention is:

a program that causes a computer to execute a security method for defending against unauthorized invasion to a network system. The security method includes:

a step of receiving a packet from an invasion device that attempts unauthorized invasion;

a step of managing whether or not to activate a plurality of virtual simulated devices by referring to characteristic information of the plurality of virtual simulated devices stored in advance;

a step of determining whether or not the plurality of activated simulated devices respond based on a request included in the packet;

a step of generating a simulated response according to the request to the simulated devices, for each of the simulated devices that is determined to respond; and

a step of transmitting the simulated response to the invasion device.

### Advantageous Effects of Invention

According to the present invention, it is possible to provide a high-secured security system, security method, and program.

### BRIEF DESCRIPTION OF DRAWINGS

FIG. 1 is a diagram illustrating an overall configuration of a security system;

FIG. 2 is a block diagram illustrating a configuration of a security device according to a first example embodiment;

FIG. 3 is a diagram illustrating layers of a communication protocol;

FIG. 4 is a diagram illustrating characteristic information of a simulated host included in a simulated response generated according to a search request;

FIG. 5 is a block diagram illustrating a configuration of a security device according to a second example embodiment; and

FIG. 6 is a block diagram illustrating a configuration of a security system according to a third example embodiment.

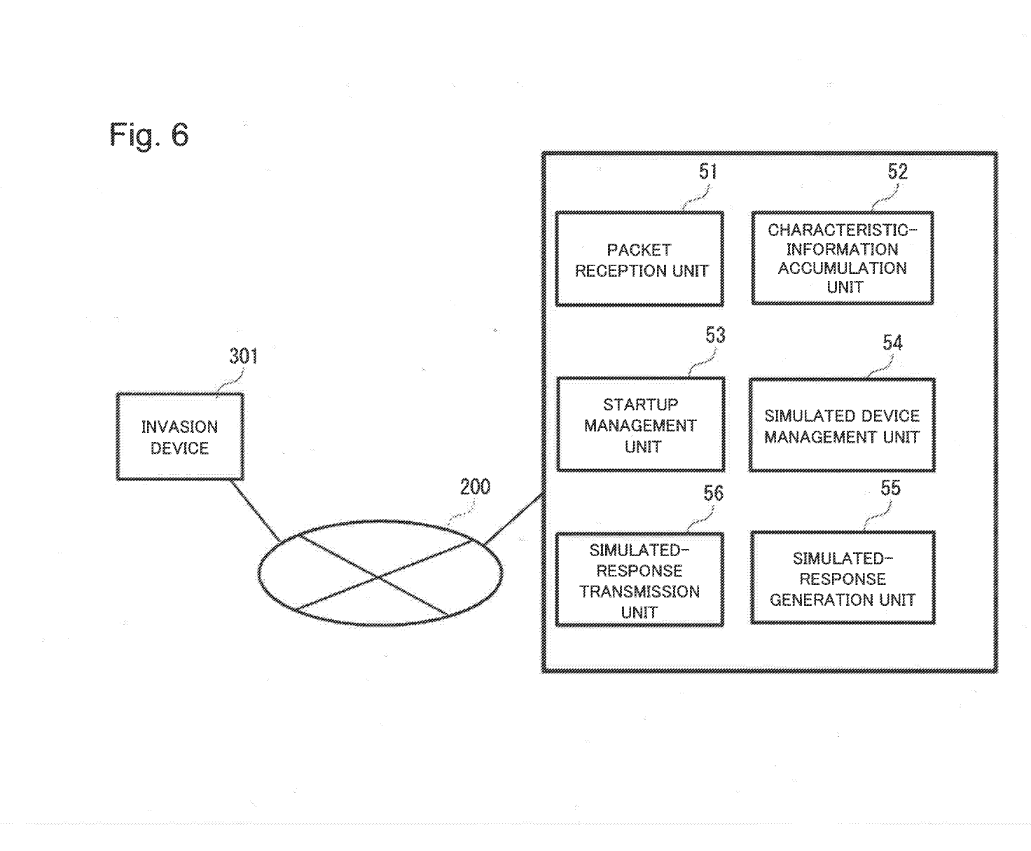

### DESCRIPTION OF EMBODIMENTS

Example embodiments of the present invention are described referring to the accompanying drawings. Example embodiments described in the following are examples of the present invention. The present invention is not limited to the following example embodiments. Note that constituent elements with the same reference signs in the present specification and drawings are identical to each other.

### First Example Embodiment

A security system and a security method according to the example embodiment are configured to enhance the security on the basis of a defense in depth. For instance, in a cyber kill chain, there are attacking steps such as espionage, invasion, hiding, securing a bridgehead, reconnaissance, penetration, occupation, exploitation, and withdrawal. In the example embodiment, a security system provides various deceptions in each of the attacking steps. For instance, a virtual communication device group (simulated deception) is generated, and in a reconnaissance step or in a penetration step, the security system gives vague information, false information, or unclear information to an attacker. This makes it possible to obstruct or guide the behavior of a malicious attacker, and to increase the attack cost required for the malicious attacker to achieve a goal. Specifically, it is possible to increase the attack cost required for an attacker to reach important data. This makes it possible to prevent important data such as intellectual properties from being leaked to the outside.

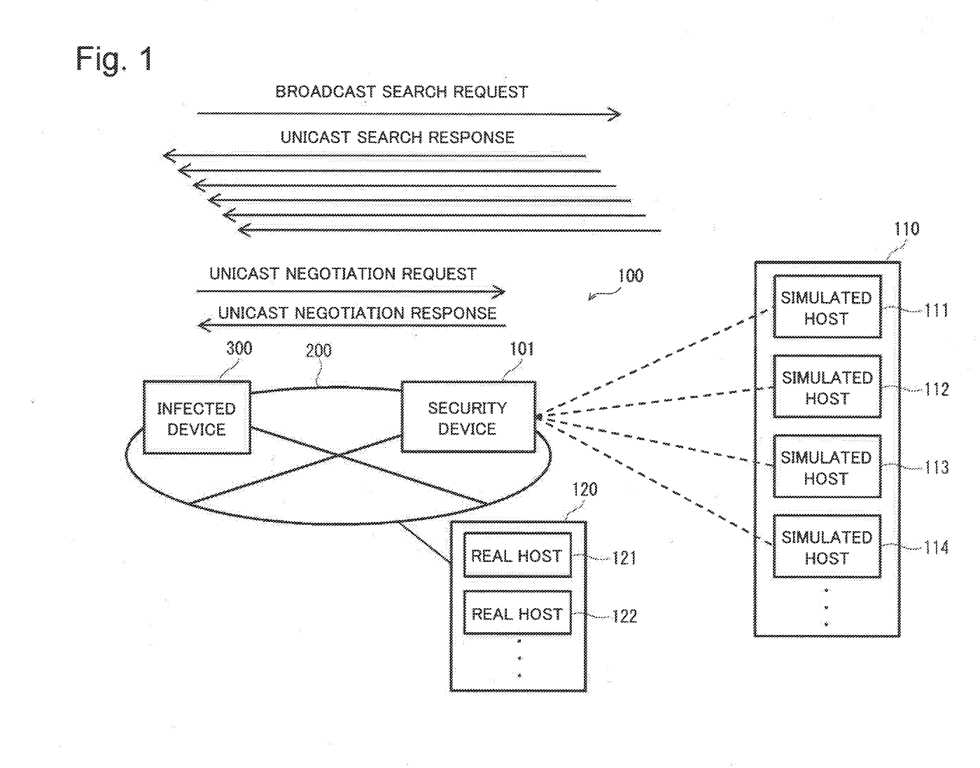

A security system 100 based on the aforementioned idea is described. FIG. 1 is a diagram illustrating an overall configuration of the security system 100 according to the example embodiment. The security system 100 includes a security device 101, a real network system 120, and a simulated network system 110. The security device 101, the real network system 120, and the simulated network system 110 are connected to each other via a network 200. Further, an infected device 300 as an attacker is connected to the network 200.

The real network system 120 includes a plurality of real hosts 121 and 122, and the like. Each of the real hosts 121 and 122 is an actually existing communication device (a host device, a computer, or a communication terminal), and is connected via a network such as an LAN (Local Area Network), a WAN (Wide Area Network), or the Internet. Note that in FIG. 1, two real hosts 121 and 122 are illustrated, however, the number of real hosts 121 and 122 is not specifically limited.

Network management information, for instance, a computer name (or a NetBIOS name), an IP address, an MAC address, a domain name, a group name, or a network manager name is set in each of the real hosts 121 and 122. An OS (Operating System) such as Windows (a registered trademark) or Linux (a registered trademark) is loaded in each of the real hosts 121 and 122.

The security device 101 generates the simulated network system 110. The simulated network system 110 is constituted by a plurality of simulated hosts 111 to 114. Each of the simulated hosts 111 to 114 is a virtual communication device (a virtual host device), in other words, a communication device that does not actually exist. The security device 101 generates the simulated hosts 111 to 114 in the same manner as a virtual honeypot. The security device 101 provides various deceptions so that the simulated hosts 111 to 114 that do not actually exist appear to exist.

Note that the security device 101 may be constituted by an actually existing real host. For instance, the security device 101 executes a security method according to the example embodiment by a network security program installed in the security device 101. Further, the security device 101 may be a dedicated computer, or may use a computer included in the real network system 120 as a real host. Further, the security device 101 is not limited to a physically single device, but may be constituted by a plurality of devices.

Causing the security device 101 to generate the simulated hosts 111 to 114 as deceptions makes it possible to increase the attack cost required for the infected device 300 to attempt stealing important data. The security device 101 virtually generates the simulated hosts 111 and 112. Therefore, it is possible to increase the number of simulated hosts at a low cost. Generating multitudes of simulated hosts 111 and 112 makes it easier to deceive an attacker. Note that the number of simulated hosts 111 to 114 to be generated by the security device 101 is not specifically limited. Causing the security device 101 to generate a larger number of simulations makes it possible to further increase the attack cost.

The security system 100 according to the example embodiment defends against unauthorized invasion from the infected device 300. Assume that the infected device 300 is a communication device (a host) infected with a malware, for instance. The infected device 300 attempts unauthorized invasion to the real network system 120 by remote control from the outside. Assume that the infected device 300 attempts to steal important data from the real hosts 121, 122, and the like included in the real network system 120, for instance. Note that an invasion device which attempts unauthorized invasion to the real network system 120 is not limited to the infected device 300 infected with a malware, but may be an external communication device connected via an external network such as the Internet.

The security device 101, the infected device 300, and the real network system 120 are connected via the network 200. Note that the security device 101, or the real hosts 121 and 122 may be connected to the network 200 via a firewall.

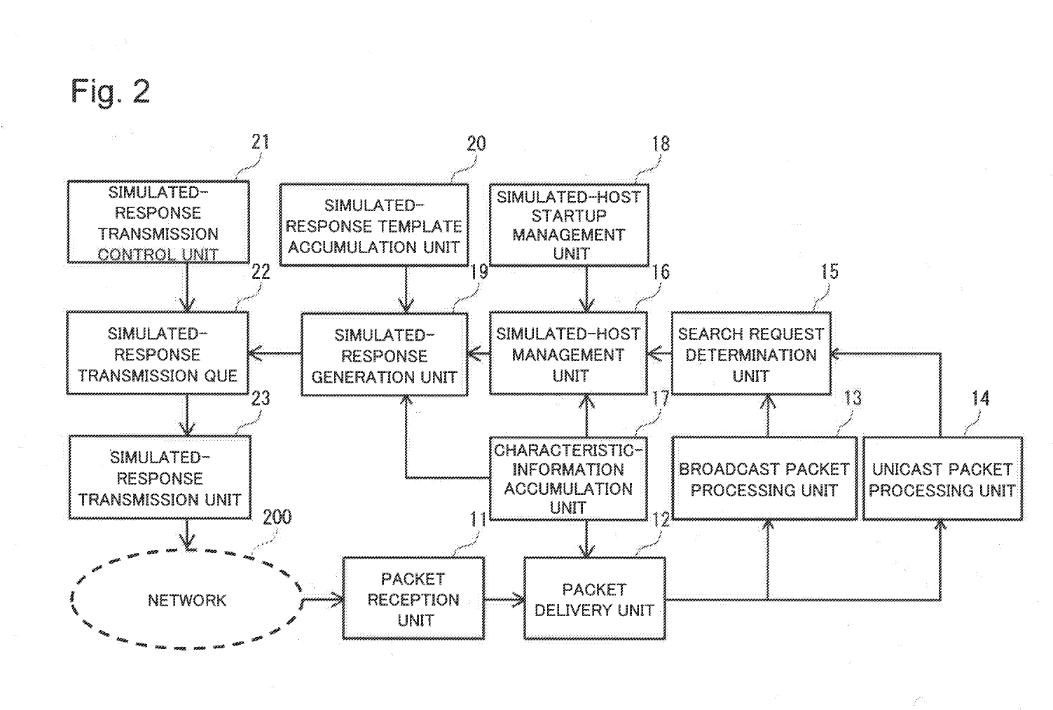

Next, a configuration of the security device 101 is described using FIG. 2. FIG. 2 is a block diagram schematically illustrating a configuration of the security device 101. The security device 101 includes a packet reception unit 11, a packet delivery unit 12, a broadcast packet processing unit 13, a unicast packet processing unit 14, a search request determination unit 15, a simulated-host management unit 16, a characteristic-information accumulation unit 17, a simulated-host startup management unit 18, a simulated-response generation unit 19, a simulated-response template accumulation unit 20, a simulated-response transmission control unit 21, a simulated-response transmission que 22, and a simulated-response transmission unit 23. In the following, processing of each of the units is described.

The packet reception unit 11 receives a packet flowing on the network 200. The packet reception unit 11 receives the packet when the transmission destination address of the packet is a predetermined address. The packet reception unit 11 receives a packet from the infected device 300 which attempts unauthorized invasion.

The packet delivery unit 12 determines the type of a received packet received by the packet reception unit 11. Specifically, the packet delivery unit 12 determines whether a packet is a broadcast packet or a unicast packet. Further, the packet delivery unit 12 delivers the broadcast packet to the broadcast packet processing unit 13, and delivers a uni-packet to the unicast packet processing unit 14. Further, the packet delivery unit 12 identifies whether a transmission destination address is included in the addresses of the simulated hosts 111 to 114 by referring to the characteristic-information accumulation unit 17.

Note that the unicast packet is a packet for use in designating a single address, and performing one-to-one data communication. The broadcast packet is a packet for use in designating a broadcast address, and performing one-to-multiple data communication. The broadcast packet includes a message targeted for all the real hosts 121 and 122, and the simulated hosts 111 to 114. For instance, the infected device 300 transmits the broadcast packet, and attempts to acquire information relating to the real hosts 121 and 122 in the real network system 120.

Note that the broadband cast packet may be a multicast packet. For instance, when receiving the multicast packet, the packet delivery unit 12 may deliver the multicast packet to the broadcast packet processing unit 13. Further, the broadcast packet processing unit 13 may process the multicast packet. Furthermore, the security device 101 may include a multicast packet processing unit. Note that the multicast packet is a packet for use in performing one-to-multiple data communication.

Specifically, the infected device 300 transmits a broadcast packet including a search message such as search of a communication device (a host) or search of a network service, as a broadcast search request (see FIG. 1). For instance, this search request message is a NetBIOS Name Service (NBNS) message. Further, the real hosts 121 and 122, or the simulated hosts 111 to 114 transmit a response to the search request to the infected device 300, as a unicast search response. After search is finished, the infected device 300 transmits a unicast negotiation request to a specific host. For instance, this request message is an SMB (Server Message Block). The simulated hosts 111 to 114, or the real hosts 121 and 122 transmit a unicast negotiation response to the infected device 300.

More specifically, the infected device 300 transmits the unicast negotiation request in relation to a response to the aforementioned broadcast search request. In the example of FIG. 1, only one unicast negotiation is illustrated. However, a unicast negotiation may be performed by the number of times equal to the number of hosts. In the configuration of FIG. 1, when the infected device 300 receives six unicast search responses from the real hosts 121 and 122 and from the simulated hosts 111 to 114, a unicast negotiation is performed successively with respect to all the six requests. Further, a plurality of sequences may be performed with respect to one host. In this case, a plurality of sequences are performed by the number of hosts. Further, when a session is established, the infected device 300 attempts file sharing with a host device. Specifically, the infected device 300 attempts file sharing by an SMB (Server Message Block). In this way, the infected device 30 attempts to steal data.

Referring back to the description of FIG. 2, the characteristic-information accumulation unit 17 stores characteristic information of the plurality of virtual simulated hosts 111 to 114. Characteristic information is information necessary for a simulated host to be simulated, and is set for each simulated host. For instance, the simulated-host startup management unit 18 manages activation of the simulated hosts 111 to 114 on the basis of characteristic information. Note that the simulated-host management unit 16 manages the simulated hosts 111 to 114 on the basis of characteristic information. The simulated-host management unit 16 and the simulated-host startup management unit 18 will be described later.

For instance, characteristic information includes a computer name (or a NetBIOS name), an IP address, an MAC address, a domain name, OS information (e.g., an OS name and a version of OS), a group name, and a network manager name. Needless to say, the aforementioned information is an example. Therefore, characteristic information may include information other than the above, or may exclude a part of the aforementioned information. The characteristic-information accumulation unit 17 may store characteristic information of the plurality of simulated hosts 111 to 114 as a table, for instance. Further, the characteristic-information accumulation unit 17 may store a network distance of the simulated hosts 111 to 114 for each simulated host. The characteristic-information accumulation unit 17 stores characteristic information equivalent to network management information of the real hosts 121 and 122, as characteristic information of the simulated hosts 111 to 114.

Further, the characteristic-information accumulation unit 17 may register a simulated host including the same management information as the information included in the real hosts 121 and 122. For instance, characteristic information of the simulated host 111 is made to coincide with a computer name (or a NetBIOS name), an IP address, an MAC address, OS information, a domain name, a group name, or a network manager name of the real host 121. This causes the real host 121 to appear to exist even when the real host 121 is deactivated. Needless to say, the characteristic-information accumulation unit 17 may register a simulated host that has no relationship with the real hosts 121 and 122.

The broadcast packet processing unit 13 transfers a broadcast packet to the simulated-host management unit 16 as it is. The unicast packet processing unit 14 discriminates whether a unicast packet is a TCP (Transmission Control Protocol) packet or a UDP (User Datagram Protocol) packet. When it is discriminated that the unicast packet is a TCP packet, the unicast packet processing unit 14 executes 3-way handshake, and transfers a payload to the search request determination unit 15. On the other hand, when it is discriminated that the unicast packet is a UDP packet, the unicast packet processing unit 14 transfers the UDP packet to the simulated-host management unit 16 as it is.

The search request determination unit 15 determines whether or not the search request is included in the received packet. For instance, the search request determination unit 15 determines whether the search request is a search message such as search of a communication device (a host device) or search of a network service, or a message indicating acquiring information details of negotiation or the like of a session. The search request determination unit 15 determines whether or not a message belonging to search is included in a payload of a TCP packet.

When a message belonging to search is included, the search request determination unit 15 determines that there is the search request. Further, the search request determination unit 15 allows the message belonging to search to pass through to the simulated-host management unit 16 as the search request. In this way, the search request determination unit 15 determines whether or not a message included in the received packet is a search-based message (a search request). Further, the search request determination unit 15 allows only the search request to pass, and does not allow a request other than the search request to pass. For instance, the search request determination unit 15 does not allow a message requesting file sharing to pass. Providing the search request determination unit 15 with the aforementioned determination function and a filtering function makes it possible to prevent leakage of important data.

The search request determination unit 15 determines whether or not there is the search request with use of a whitelist, for instance. Specifically, the search request determination unit 15 allows only a message registered in advance in a list to pass through to the simulated-host management unit 16 as the search request. This makes it possible to filter a malicious attack, and to enhance the security.

Note that it is possible to set the whitelist in combination with various characteristic information of a simulated host. Changing a message that is allowed to pass for each simulated host or the like as described above makes it possible to change the degree of achievement of a successful sequence for each simulated host. Therefore, this makes it possible to provide more deceptive deception.

The simulated-host startup management unit 18 manages whether or not to activate each of the simulated hosts by referring to the characteristic-information accumulation unit 17. Specifically, the simulated-host startup management unit 18 manages whether or not to activate the simulated devices on the basis of characteristic information. The simulated-host startup management unit 18 determines whether to activate or deactivate each of the simulated hosts 111 to 114 included in the characteristic-information accumulation unit 17.

For instance, the simulated-host startup management unit 18 manages activation of a simulated host by using an external request as a trigger. Specifically, in response to receiving a request (an activation request) indicating ON of the simulated host 111, the simulated-host startup management unit 18 activates the simulated host 111. In response to receiving a request (a deactivation request) indicating OFF of the simulated host 111, the simulated-host startup management unit 18 stops activation of the simulated host 111. Further, the simulated-host startup management unit 18 outputs, to the simulated-host management unit 16, activation information indicating whether or not each of the simulated hosts is activated. The simulated-host startup management unit 18 manages activation of a plurality of simulated hosts included in the characteristic-information accumulation unit 17 independently of each other. The simulated-host startup management unit 18 is capable of dynamically changing an activated simulated host.

The simulated-host management unit 16 manages a simulated host to be simulated on the basis of activation information from the simulated-host startup management unit 18. Specifically, the simulated-host management unit 16 determines whether or not the simulated host performs a simulated response. For instance, when there is a request to an activated simulated host, the simulated-host management unit 16 determines that the simulated host responds. On the other hand, regarding a deactivated simulated host, the simulated-host management unit 16 determines that the deactivated simulated host does not perform a simulated response. Note that in the following description, there is described an example in which the simulated host 113 is activated and the simulated host 112 is deactivated.

Further, the simulated-host management unit 16 determines whether or not a response according to the search request is performed by referring to the characteristic-information accumulation unit 17. For instance, the simulated-host management unit 16 specifies a simulated host which responds on the basis of a transmission destination address included in the received packet. Specifically, the simulated-host management unit 16 determines that a simulated host, including an address which coincides with a transmission destination address included in the received packet, responds. Note that when receiving the broadcast packet, the simulated-host management unit 16 determines that all the activated simulated hosts respond.

Further, when a search request is included in a packet, the simulated-host management unit 16 determines that a simulated host as a target of the search request performs a simulated response. The simulated-host management unit 16 determines whether or not the simulated host is the target of the search request by referring to a transmission destination address of the packet. The simulated-host management unit 16 determines whether or not the simulated host responds on the basis of a result of comparison between the transmission destination address and characteristic information, and a determination result by the search request determination unit 15. The simulated-host management unit 16 determines whether or not a response is necessary for each activated simulated host.

When the activated simulated host 113 receives a search request, the simulated-host management unit 16 determines that the activated simulated host 113 is caused to perform a simulated response as if the simulated host 113 exists. On the other hand, when a simulated host is not an activated simulated host, when a search request is not included in a packet, or when a simulated host is not the simulated host as the target of the search request, the simulated-host management unit 16 determines that the simulated host does not perform a simulated response. With respect to the deactivated simulated host 112, the simulated-host management unit 16 causes the simulated host 112 to stop responding. Further, even an activated simulated host is not allowed to perform a simulated response unless the simulated host receives the search request. The simulated-host management unit 16 determines that all the activated simulated hosts as targets of the search request are required to respond.

Note that an external request with respect to the simulated-host startup management unit 18 is implementable by a setting file, an API (Application Programming Interface), an IF (Interface), or the like. a setting file is, for instance, schedule data set in advance and an activation time or a deactivation time is set for each simulated host, for instance. The security device 101 may store a setting file. Further, the simulated-host startup management unit 18 may manage activation of a simulated host by a request from a real host.

In the following, an example of management by the simulated-host startup management unit 18 is described. In this example, regarding the characteristic-information accumulation unit 17, it is assumed that the same address or the like as the real host 121 is registered in the simulated host 111. For instance, information for configuring the simulated host 111 related to the real host 121 is stored in the simulated-host startup management unit 18 in advance or according to a request. Specifically, characteristic information obtained by copying management information of the real host 121 is set in the simulated host 111. In this case, when the real host 121 is in an ON-state, the simulated-host startup management unit 18 stops activation of the simulated host 111. On the other hand, when the real host 121 is in an OFF-state, the simulated-host startup management unit 18 activates the simulated host 111. Specifically, the simulated-host startup management unit 18 designates activation of the simulated host 111 at a timing when the real host 121 is shut down. On the other hand, the simulated-host startup management unit 18 designates deactivation of the simulated host 111 at a timing when the real host 121 is activated.

In this way, the simulated-host startup management unit 18 deactivates/activates the simulated host 111 by using ON/OFF of the real host 121 as a trigger. Even in a condition that the real host 121 is disconnected from the network 200, the simulated host 111 exists on the network 200. This makes it possible to provide more deceptive deception against an attacker. The real host 121 appears to exist when viewed from the infected device 300. In this way, the simulated-host startup management unit 18 may manage activation of the simulated host 111 according to whether or not the real host 121 is activated.

The simulated-response template accumulation unit 20 stores a simulated-response template relating to a search request. For instance, the simulated-response template accumulation unit 20 holds a message format by hard coding. Further, the simulated-response template accumulation unit 20 stores a message format of a response sentence. The simulated-response template accumulation unit 20 stores a template for each request or for each protocol. The simulated-response template accumulation unit 20 stores a message response sentence relating to a requested service as a template. The simulated-response template accumulation unit 20 stores a plurality of templates.

The simulated-response generation unit 19 generates a simulated response according to a request from the simulated-host management unit 16. When the simulated-host management unit 16 determines that a simulated host responds, the simulated-response generation unit 19 generates a simulated response according to a request to the simulated host. In generating the simulated response, the simulated-response generation unit 19 refers to the template accumulated in the simulated-response template accumulation unit 20. This allows the simulated-response generation unit 19 to generate a simulated-response message appropriate for the request.

Further, the simulated-response generation unit 19 acquires, from the characteristic-information accumulation unit 17, characteristic information of a simulated host to respond. Further, the simulated-response generation unit 19 generates the simulated-response message by combining characteristic information and the response message format. Specifically, the simulated-response generation unit 19 generates a simulated-response message in a state that an address, OS information, and the like included in characteristic information is included in the message format. Specifically, the simulated-response generation unit 19 generates a simulated-response message including simulated information relating to the simulated host 111. This makes it possible to provide more deceptive deception.

The simulated-response template accumulation unit 20 stores a template according to a service usable by the simulated hosts 111 to 114. Further, when the simulated host 111 and the simulated host 112 can use the same service, the simulated-response generation unit 19 generates the simulated-response message of the simulated host 111 and the simulated host 112 with use of a common template. Further, the simulated-response template accumulation unit 20 stores response templates with respect to all the messages included in the whitelist of the search request determination unit 15. As the number of types of templates increases, the number of types of related requests increases. Further, it is not necessary that the content set in a whitelist coincides with the content of the simulated-response template accumulation unit 20, and the content may be set independently. For instance, a message set in the whitelist may be such that only a part of the template is usable.

The simulated-response transmission que 22 ques the simulated-response message generated in the simulated-response generation unit 19. The simulated-response transmission unit 23 transmits the simulated-response message queued in the simulated-response transmission que 22 to the infected device 300 as a simulated response. The simulated-response transmission unit 23 transmits a simulated response by a packet in which the address of the infected device 300 is set as a transmission destination address.

Further, the simulated-response message accumulated in the simulated-response transmission que 22 is transmitted to a network by an instruction of the simulated-response transmission control unit 21 via the simulated-response transmission unit 23. Specifically, the simulated-response transmission unit 23 controls a transmission timing of a simulated response in the simulated-response transmission unit 23. The simulated-response transmission unit 23 transmits the simulated-response message to the infected device 300 via the network 200 at a timing according to an instruction of the simulated-response transmission control unit 21.

As described above, the simulated-response transmission control unit 21 controls a transmission timing of a simulated response accumulated in the simulated-response transmission que 22. For instance, the simulated-response transmission control unit 21 controls to transmit a simulated-response message in the queuing order. Alternatively, the simulated-response transmission control unit 21 may control to transmit the simulated-response message at random. Further alternatively, the simulated-response transmission control unit 21 may transmit the simulated-response message according to a pattern. The control of the simulated-response transmission control unit 21 makes it possible to change the order of transmission of a simulated response. The simulated-response transmission unit 23 transmits a simulated response of the simulated-response transmission que 22 to the network 200 on the basis of an instruction by the simulated-response transmission control unit 21.

For instance, in response to receiving a broadcast message indicating a search request, the simulated-response generation unit 19 generates a simulated-response message by the number equal to the number of activated simulated hosts. Further, the simulated-response transmission que 22 ques the simulated-response message in the order of simulated hosts accumulated in the characteristic-information accumulation unit 17. For instance, the simulated-response transmission que 22 ques the simulated-response message in the order of the simulated host 111, the simulated host 112, the simulated host 113, and the simulated host 114. Further, the simulated-response transmission unit 23 transmits the simulated-response message in the queuing order. Alternatively, the simulated-response transmission unit 23 may transmit the simulated-response message in the order at random. Further alternatively, when a response timing is set in the simulated-response transmission control unit 21 for each simulated host, the simulated-response transmission unit 23 may transmit the simulated-response message according to the response timing. Further, the simulated-response transmission unit 23 may transmit the simulated-response message in the order or at a timing according to a preset schedule.

The simulated-response transmission control unit 21 controls a timing of a simulated response in the simulated-response transmission unit 23 for each simulated host. Note that a response timing may be set according to a network distance stored in the characteristic-information accumulation unit 17. Specifically, the simulated-response transmission control unit 21 delays a response timing of a simulated host whose network distance is long. Further, the simulated-response transmission control unit 21 speeds up a response timing of a simulated host whose network distance is short. The simulated-response transmission control unit 21 may set a delay time according to a network distance by referring to the characteristic-information accumulation unit 17. In this way, allowing the simulated-response transmission control unit 21 to control a transmission timing of a simulated-response message causes the simulated hosts 111 to 114 to appear to exist when viewed from the infected device 300. Specifically, it is possible to provide more deceptive deception against an attacker.

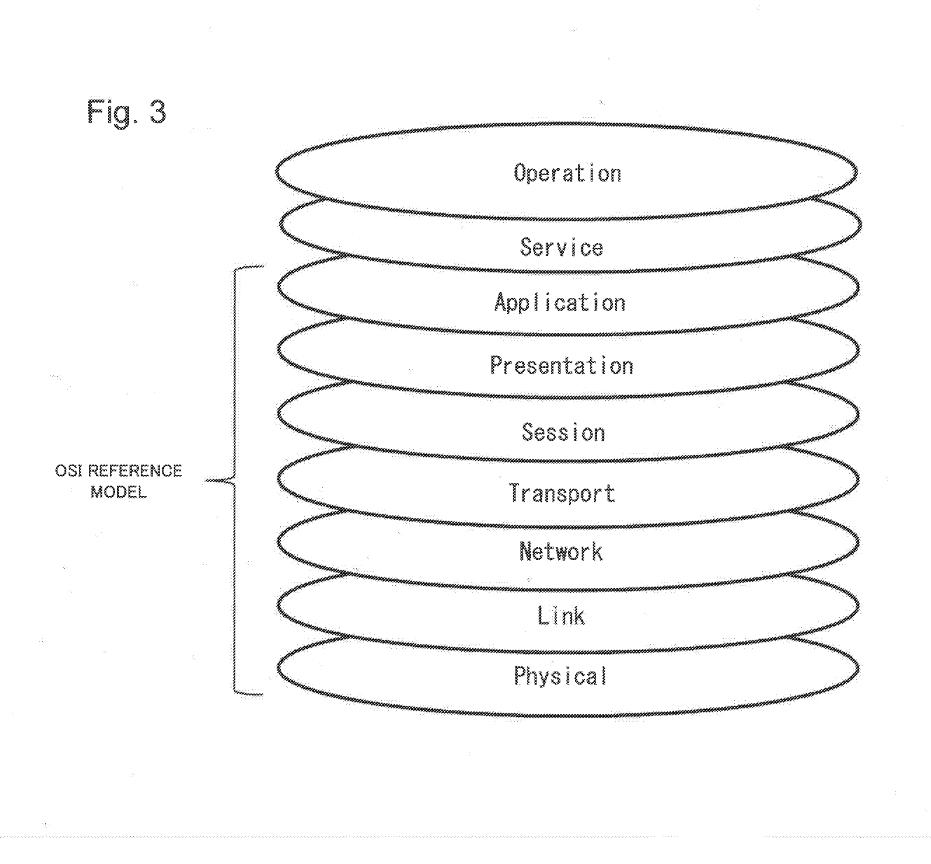

Note that a communication protocol of the network 200 has a layer configuration as illustrated in FIG. 3. The communication functions are defined separately in nine layers as illustrated in FIG. 3. A physical layer is defined as the first layer, a datalink layer is defined as the second layer, a network layer is defined as the third layer, a transport layer is defined as the fourth layer, a session layer is defined as the fifth layer, a presentation layer is defined as the sixth layer, an application layer is defined as the seventh layer, a service layer is defined as the eighth layer, and an operation layer is defined as the ninth layer.

The seven layers from the physical layer to the application layer serve as a well-known OSI reference model. Further, the service layer and the operation layer are provided as upper layers than the application layer. The service layer is a layer based on an assumption that a service is provided by an application. The operation layer is a layer based on an assumption that information is set in an operation of a computer name or the like. The simulated-response generation unit 19 generates a simulated-response message including information relating to a service of an application or information relating to an operation of a computer when actually operating an application software.

A well-known virtual honeypot is related to the layers up to the transport layer as the fourth layer. As a result, a simulated host does not appear to exist in the upper layers than the transport layer. Therefore, an attacker may immediately find out that a simulated host is a virtual device. In the example embodiment, however, a related simulated-response message is also transmitted to a session layer, a presentation layer, an application layer, a service layer, and an operation layer, which are upper layers than a transport layer. Specifically, it is sufficient that a simulated response includes simulated information relating to at least one layer out of a session layer, a presentation layer, an application layer, a service layer, and an operation layer. The simulated-response generation unit 19 generates a simulated response including information relating to upper layers than a network layer.

More specifically, the simulated-response generation unit 19 generates: a simulated-response message including information of a session layer; a simulated-response message including information of a session layer and a presentation layer; a simulated-response message including information of a session layer, a presentation layer, and an application layer; a simulated-response message including a session layer, a presentation layer, an application layer, and a service layer; or a simulated-response message including information of a session layer, a presentation layer, an application layer, a service layer, and an operation layer.

Further, a simulated-response message may preferably include information of one or more layers out of an application layer, a service layer, and an operation layer. Still further, information relating to a service of an application or an operation of a computer is included. Including layer information as described above makes it possible to transmit a more deceptive simulated response.

In this way, a simulated response which causes the simulated hosts 111 to 114 to appear to be the real hosts 121 and 122 is generated. Therefore, it is possible to securely deceive the infected device 300. Specifically, including information equivalent to a case of performing reconnaissance of the real hosts 121 and 122 in a simulated-response message causes a simulated host to appear to be a real host when viewed from the infected device 300. This provides more deceptive deception against an attacker. Therefore, this is advantageous in increasing the attack cost, and in enhancing the security.

Further, the simulated-response generation unit 19 generates a simulated-response message including information relating to all the layers. For instance, information relating to all the layers is incorporated in templates stored in the simulated-response template accumulation unit 20. Thus, a simulated response is performed in such a way that a real host appears to exist when viewed from any of the layers. Therefore, it is possible to provide more deceptive deception against an attacker.

The security device 101 performs a simulated response of a part corresponding to negotiation with respect to a plurality of simulated hosts. Then, a session between the infected device 300 and the plurality of simulated hosts is established. Therefore, multitudes of simulated hosts appear to exist on a network when viewed from the infected device 300. The security device 101 does not perform a simulated response regarding an actual function (a service) after a session is established by negotiation. This makes it possible to prevent leakage of important data due to file sharing or the like. Therefore, this is advantageous in enhancing the security.

As described above, in the security system 100 according to the example embodiment, the characteristic-information accumulation unit 17 includes characteristic information of a plurality of simulated hosts. The simulated-host startup management unit 18 manages activation of a plurality of simulated hosts on the basis of characteristic information. The simulated-host management unit 16 determines whether or not a plurality of simulated hosts activated by the simulated-host startup management unit 18 respond on the basis of a request included in a packet. Further, the simulated-response generation unit 19 generates a simulated response for each simulated host, and the simulated-response transmission unit 23 transmits the simulated response. This causes a simulated host to appear to exist. Specifically, it is possible to provide, to the infected device 300, an illusion of the simulated network system 110 provided with a plurality of simulated hosts.

Further, the simulated-response transmission control unit 21 controls a transmission timing of a simulated response. This makes it possible to provide more deceptive deception. Further, the search request determination unit 15 allows a request to pass only in the case of a search request, and filters a request other than search (e.g., a request for file sharing). This makes it possible to prevent leakage of important data. Further, the search request determination unit 15 may dynamically change a request which is allowed to pass. Specifically, the search request determination unit 15 may dynamically change a threshold value for use in determining whether or not to allow a request to pass.

Further, the security device 101 generates the plurality of simulated hosts 111 to 114 regardless of whether or not a communication device as a packet transmission source is a malicious attacker. Therefore, it is not necessary to detect whether a communication device is a malice attacker. This is advantageous in enhancing the security against an elaborate attack with concealed malice.

In addition, increasing the number of simulated hosts accumulated in the characteristic-information accumulation unit 17 makes it easy to deceive an attacker. Further, appropriately setting information to be accumulated in the characteristic-information accumulation unit 17 makes it easy to deceive an attacker. For instance, an address appropriate for a network in which an IP address is set may be utilized as an address to be accumulated in the characteristic-information accumulation unit 17. Alternatively, an address to be accumulated in the characteristic-information accumulation unit 17 may be acquired from an actual DHCP server that exists on a network by a DHCP. Further, when an MAC address uses a configuration of a vendor code plus number, it is also possible to generate the address according to this configuration.

Regarding a domain name, it is preferable to set a character string used in a real network system when the same character string is used for each domain. Regarding a group name, it is possible to use the same character string as the group name of the real network system 120. Alternatively, it is possible to set a group name in such a manner that several groups are configured. An OS name and a network manager name may be selected from one of actually existing limited variations.

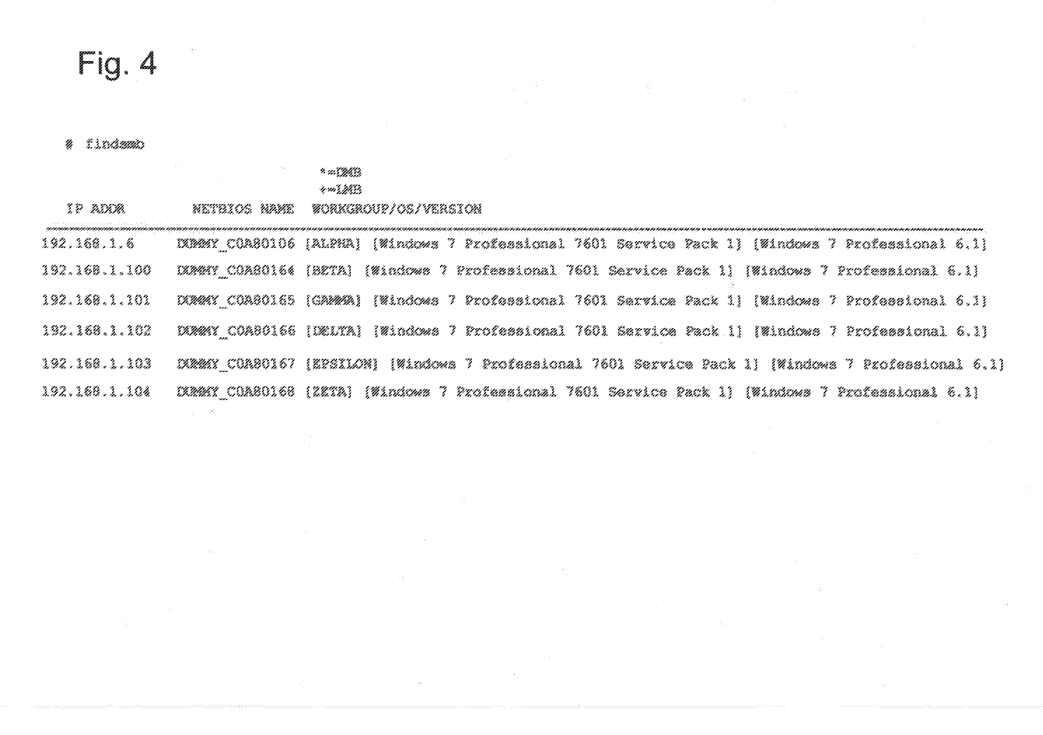

FIG. 4 is a diagram illustrating information of simulated hosts acquired by a search request of the infected device 300. As illustrated in FIG. 4, the infected device 300 acquires IP addresses, NETBIOS, group names, OS, and versions of OS of simulated hosts by an SMB protocol (findSMB). FIG. 4 illustrates characteristic information of six simulated hosts acquired by a search request of the infected device 300. In this way, giving information relating to a plurality of simulated hosts to the infected device 300 makes it possible to increase the attack cost required for an external invader to reach targeted data. Therefore, this is advantageous in setting the cost advantage of a defender-side high, and in implementing high security.

Note that the simulated-response generation unit 19 generates a simulated-response message by referring to a template stored in the simulated-response template accumulation unit 20. Alternatively, a simulated-response message may be automatically generated. For instance, a response message may be generated with respect to a service requested by the real host 121 or by the security device 101, and a part of information may be replaced by information relating to a simulated host.

Note that in the aforementioned example embodiment, an access recording unit which records access from the infected device 300 may be provided. Specifically, information relating to a received packet, i.e., a received request is recorded. Further, the security device 101 utilizes the access information for detection of unauthorized invasion, an incident response, a forensic analysis, or the like.

### Second Example Embodiment

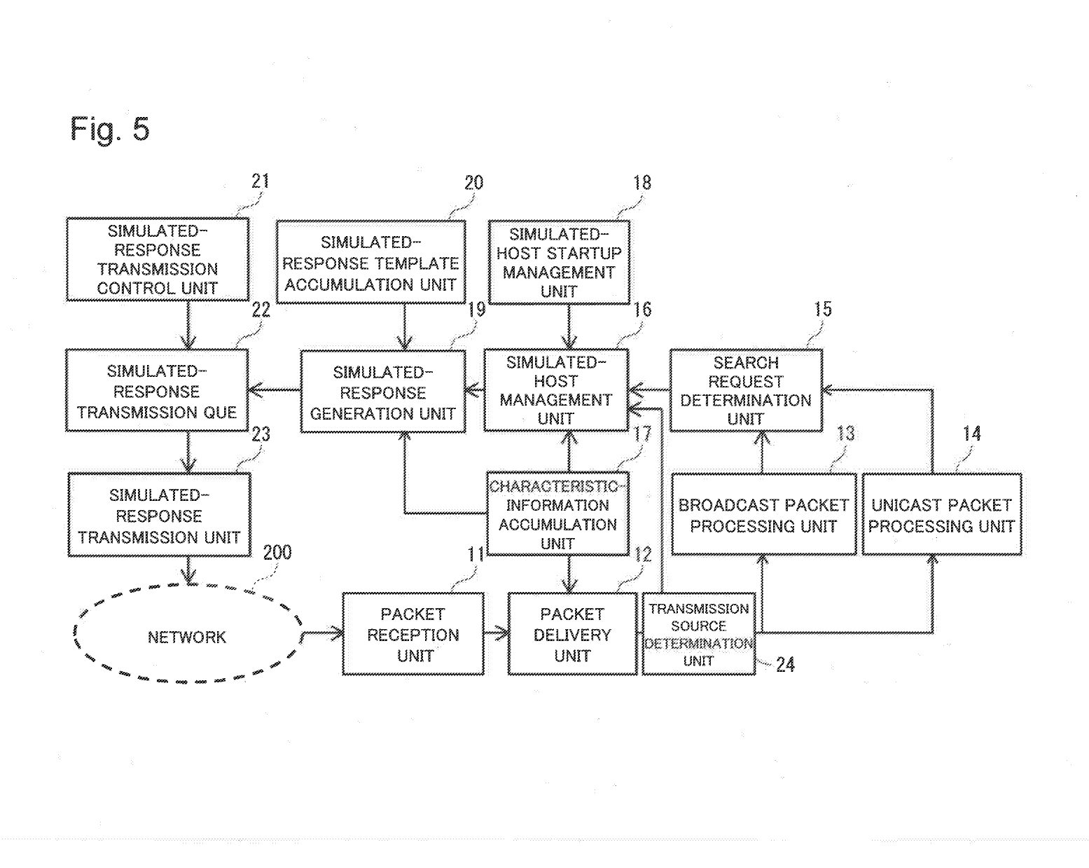

A security device according to the example embodiment is described using FIG. 5. FIG. 5 is a block diagram illustrating a configuration of a security device 101. Note that the overall configuration of a security system 100 is the same as in the first example embodiment, and therefore, description thereof is omitted. The security device 101 according to the second example embodiment has a configuration in which a transmission source determination unit 24 is additionally provided with respect to the configuration of the first example embodiment. Note that the configuration of the second example embodiment other than the transmission source determination unit 24 is the same as in the first example embodiment, and therefore, description thereof is omitted.

The transmission source determination unit 24 determines a transmission source of a received packet. For instance, during reconnaissance by the infected device 300, the security device 101 detects that the infected device 300 is a malicious attacker. Alternatively, another detection device (a real host) may detect unauthorized invasion, and may notify the security device 101 of the detection. Further, when the security device 101 detects that the infected device 300 is the malicious attacker, the transmission source determination unit 24 extracts a transmission source address of the infected device 300. Further, the transmission source determination unit 24 transmits information of the transmission source address to the simulated-host management unit 16. The simulated-host management unit 16 performs simulated host management with respect to a specific transmission source. Specifically, the simulated-host management unit 16 manages a simulated host so that a simulated response is performed only to a malicious transmission source. Therefore, simulated hosts 111 and 112 appear to exist only when viewed from the infected device 300. In other words, a simulated host is not visible when viewed from a normal non-malicious communication device. This causes a simulated host not to respond to a request from a normal communication device. Therefore, in the example embodiment, it is possible to suppress an influence on a normal communication device.

### Third Example Embodiment

A security system according to the example embodiment is described. The security system is a security system which defends against unauthorized invasion to a network system. The security system includes: a packet reception unit 51 that receives a packet from an invasion device that attempts unauthorized invasion; a characteristic-information accumulation unit 52 that stores characteristic information of a plurality of virtual simulated devices; a startup management unit 53 that manages whether or not to activate the simulated devices on the basis of the characteristic information; a simulated device management unit 54 that determines whether or not the plurality of simulated devices activated by the startup management unit respond on the basis of a request included in the packet; a simulated-response generation unit 55 that generates a simulated response according to the request to the simulated devices for each simulated device which is determined to respond by the simulated device management unit; and a simulated-response transmission unit 56 that transmits the simulated response to the invasion device.

According to the security system 100, it is possible to provide more deceptive deception against a malicious attacker. Therefore, it is possible to increase the attack cost and implement high security. Note that it is possible to combine or replace the configurations of the first and second example embodiments with the configuration of the third example embodiment, as appropriate.

A part or all of the processing in the security methods according to the aforementioned example embodiments may be executed by a computer program. It is possible to store the aforementioned program with use of various types of non-transitory computer readable media, or to supply the program to a computer. Non-transitory computer readable media include various types of tangible storage media. Examples of non-transitory computer readable media include a magnetic recording medium (e.g., a flexible disk, a magnetic tape, or a hard disk drive), a magneto-optical recording medium (e.g., a magneto-optical disk), a CD-ROM (Read Only Memory), a CD-R, a CD-R/W, and a semiconductor memory (e.g., a mask ROM, a PROM (Programmable ROM), an EPROM (Erasable PROM), a flash ROM, and an RAM (Random Access Memory)). Further, the program may be supplied to a computer by various types of transitory computer readable media. Examples of transitory computer readable media include an electrical signal, an optical signal, and an electromagnetic wave. A transitory computer readable medium is capable of supplying the program to a computer via a wired communication path such as a cable and an optical fiber, or a wireless communication path.

The invention of the present application has been described referring to the example embodiments. The invention of the present application, however, is not limited to the aforementioned example embodiments. The configuration and the details of the invention of the present application may be modified in various ways which are comprehensible to a person skilled in the art within the scope of the invention of the present application.

This application claims the priority based upon Japanese Patent Application No. 2014-170368, filed on Aug. 25, 2014, the disclosure of which is incorporated herein in its entirety.

### REFERENCE SIGNS LIST

100 Security system
101 Security device
110 Simulated network system
111 to 114 Simulated host
120 Real network system
121 Real host
11 Packet reception unit
12 Packet delivery unit
13 Broadcast packet processing unit
14 Unicast packet processing unit
15 Search request determination unit
16 Simulated-host management unit
17 Characteristic-information accumulation unit
18 Simulated-host startup activation management unit
19 Simulated-response generation unit
20 Simulated-response template accumulation unit
21 Simulated-response transmission control unit
22 Simulated-response transmission que
23 Simulated-response transmission unit
24 Transmission source determination unit
200 Network
300 Infected device

1. A security system that defends against unauthorized invasion to a network system comprising:
one or more processors acting as a packet reception unit configured to receive a packet from an invasion device that attempts unauthorized invasion;
the one or more processors acting as a characteristic-information accumulation unit configured to store characteristic information of a plurality of virtual simulated devices;
the one or more processors acting as a startup management unit configured to manage whether or not to activate the simulated devices based on the characteristic information;
the one or more processors acting as a simulated device management unit configured to determine whether or not the plurality of simulated devices activated by the startup management means respond based on a request included in the packet;
the one or more processors acting as a simulated-response generation unit configured to generate a simulated response according to the request to the simulated devices, for each of the simulated devices that is determined to respond by the simulated device management means; and
the one or more processors acting as a simulated-response transmission unit configured to transmit the simulated response to the invasion device.

2. The security system according to claim 1, wherein
a communication protocol includes at least one layer out of a session layer, a presentation layer, an application layer, a service layer, and an operation layer, as upper layers than a transport layer, and
the simulated response includes information relating to an upper layer than a network layer.

3. The security system according to claim 1, further comprising
the one or more processors acting as a search request determination unit configured to determine whether or not a search request is included in the packet, wherein
the simulated device management unit determines that the simulated device responds when the search request is included, and
the simulated device management unit determines that the simulated device does not respond when the search request is not included.

4. The security system according to claim 1, further comprising
the one or more processors acting as a transmission control unit configured to control a timing at which the simulated-response transmission means transmits the simulated response for each of the simulated devices.

5. A security method for defending against unauthorized invasion to a network system, the security method comprising:
receiving a packet from an invasion device that attempts unauthorized invasion;
managing whether or not to activate a plurality of virtual simulated devices by referring to characteristic information of the plurality of virtual simulated devices stored in advance;
determining whether or not the plurality of activated simulated devices respond based on a request included in the packet;
generating a simulated response according to the request, for each of the simulated devices that is determined to respond; and
transmitting the simulated response to the invasion device.

6. The security method according to claim 5, wherein
a communication protocol includes at least one layer out of a session layer, a presentation layer, an application layer, a service layer, and an operation layer, as upper layers than a transport layer, and
the simulated response includes information relating to an upper layer than a network layer.

7. The security method according to claim 5, further comprising a step of determining whether or not a search request is included in the packet, wherein
the simulated device is determined to respond when the search request is included, and
the simulated device is determined not to respond when the search request is not included.

8. The security method according to claim 5, further comprising a step of controlling a timing at which the simulated response is transmitted for each of the simulated devices.

9. A non-transitory computer readable medium storing a program that causes a computer to execute a security method for defending against unauthorized invasion to a network system, the security method comprising:
receiving a packet from an invasion device that attempts unauthorized invasion;
managing whether or not to activate a plurality of virtual simulated devices by referring to characteristic information of the plurality of virtual simulated devices stored in advance;
determining whether or not the plurality of activated simulated devices respond based on a request included in the packet;
generating a simulated response according to the request to the simulated devices, for each of the simulated devices that is determined to respond; and
transmitting the simulated response to the invasion device.

10. The non-transitory computer readable medium according to claim 9, wherein
a communication protocol includes at least one layer out of a session layer, a presentation layer, an application layer, a service layer, and an operation layer, as upper layers than a transport layer, and
the simulated response includes information relating to an upper layer than a network layer.

11. The non-transitory computer readable medium according to claim 9, further comprising a step of
determining whether or not a search request is included in the packet, wherein
the simulated device is determined to respond when the search request is included, and
the simulated device is determined not to respond when the search request is not included.

12. The non-transitory computer readable medium according to claim 9, further comprising a step of
controlling a timing at which the simulated response is transmitted for each of the simulated devices.

13. The security system according to claim 2, further comprising
the one or more processors acting as a search request determination unit configured to determine whether or not a search request is included in the packet, wherein
the simulated device management unit determines that the simulated device responds when the search request is included, and
the simulated device management unit determines that the simulated device does not respond when the search request is not included.

14. The security system according to claim 2, further comprising
the one or more processors acting as a transmission control unit configured to control a timing at which the simulated-response transmission means transmits the simulated response for each of the simulated devices.

15. The security system according to claim 2, further comprising
the one or more processors acting as a transmission control unit configured to control a timing at which the simulated-response transmission means transmits the simulated response for each of the simulated devices.

16. The security system according to claim 3, further comprising
the one or more processors acting as a transmission control unit configured to control a timing at which the simulated-response transmission means transmits the simulated response for each of the simulated devices.

17. The security method according to claim 6, further comprising a step of determining whether or not a search request is included in the packet, wherein
the simulated device is determined to respond when the search request is included, and
the simulated device is determined not to respond when the search request is not included.

18. The security method according to claim 6, further comprising a step of controlling a timing at which the simulated response is transmitted for each of the simulated devices.

19. The security method according to claim 7, further comprising a step of controlling a timing at which the simulated response is transmitted for each of the simulated devices.

20. The non-transitory computer readable medium according to claim 10, further comprising a step of determining whether or not a search request is included in the packet, wherein
the simulated device is determined to respond when the search request is included, and
the simulated device is determined not to respond when the search request is not included.
